(19) United States
(12) Patent Application Publication
(10) Pub. No.: US 2008/0187794 A1
(43) Pub. Date: Aug. 7, 2008

(54) Venturi catalytic reactor inlet fuel mixer

(75) Inventors: David Weingaertner, Sunnyvale, CA (US); Vlad Kalika, San Jose, CA (US); Clem Wiser, San Jose, CA (US)

Correspondence Address: FOLEY AND LARDNER LLP;SUITE 500, 3000 K STREET NW, WASHINGTON, DC, 20007, US

(73) Assignee: Bloom Energy Corporation

(21) Appl. No.: 11/703,152

(22) Filed: Feb. 7, 2007

(51) Int. Cl. H01M 8/04

(52) U.S. Cl. 429/14; 429/12

(57) ABSTRACT

A fuel cell system includes a fuel cell stack, at least one catalytic reactor and at least one venturi. The venturi is fluidly connected to at least one catalytic reactor.

### BACKGROUND OF THE INVENTION

Catalytic reactors are commonly used in fuel cell systems for reacting components in a fluid stream and are typically sized to utilize the entire catalyst to keep costs and pressure drop to a minimum. As a result, such reactors are very sensitive to inlet composition. Uniform gas mixtures such as fuel/air mixtures aid in maintaining uniform operational temperature of catalyst and complete conversion of the gas mixture reactants.

### SUMMARY OF THE INVENTION

Embodiment of the present invention describe a fuel cell system comprising a fuel cell stack, at least one catalytic reactor and at least one venturi, fluidly connected to said at least one catalytic reactor. A method of practicing an embodiment of the present invention comprises the steps of (a) providing a fuel cell system comprising: a fuel cell stack, at least one catalytic reactor, and at least one venturi, (b) mixing fuel and air in said at least one venturi, and (c) providing a fuel and air mixture from the at least one venturi to said at least one catalytic reactor.

### BRIEF DESCRIPTION OF THE DRAWINGS

FIG. 1 is a schematic side cross sectional view of a venturi configured to mix air and fuel.

FIG. 2 is an image showing a side cross sectional view of computational fluid dynamics (CFD) simulation of fuel distribution in a venturi.

FIG. 3 is a front cross sectional view of the CFD simulation of FIG. 2.

FIG. 4 is an image showing a side cross sectional view of another CFD simulation of fuel distribution in a venturi.

FIG. 5 is a front cross sectional view of the CFD simulation of FIG. 4.

FIG. 6 depicts a schematic of a fuel cell system wherein a venturi is installed to fluidly communicate with an anode tailgas oxidizer (ATO) and catalytic partial oxidation (CPOX) reactor.

### DETAILED DESCRIPTION OF THE PREFERRED EMBODIMENTS

Embodiments of the present invention describe fuel cell systems comprising a fuel cell stack, at least one catalytic reactor and at least one venturi. Preferably, the at least one venturi is fluidly connected to at least one catalytic reactor and functions as a mixer in a fuel cell system. More preferably, the system comprises two venturis which function as mixers for two different catalytic reactors. That is, it is more preferred to have one venturi mixer for each catalytic reactor. As such, for each additional catalytic reactor in a fuel cell system, an additional venturi mixer may be used.

In the embodiments, at least one venturi is configured to deliver a mixture of fluids to a catalytic reactor in a fuel cell system. The mixture of fluids, for example, comprises fresh fuel (natural gas and/or methane) and air, or anode exhaust and air, or anode exhaust and natural gas and air.

Preferably the fuel cell stack is a solid oxide fuel cell (SOFC) stack. A detailed description of a type of SOFC system is described, in U.S. patent application Ser. Nos. 11/491,487 (filed on Jul. 24, 2006) and 11/002,681 (filed on Dec. 3, 2004), both hereby incorporated by reference in their entirety.

“Catalytic reactor” as used herein describes an element in a fuel cell system capable of catalyzing a reaction between reactants conveyed thereto. These reactors typically comprise metal catalyst-containing tubes or other conduits. Catalytic reactors may be located at various places in a fuel cell system. Examples of catalytic reactors include, but are not limited to catalytic partial oxidation (CPOX) reactor and anode tailgas oxidation (ATO) reactor.

A CPOX reactor, for example, may be used in the start-up mode of a fuel cell system, to make the system independent of an external source of hydrogen. In this example, the CPOX unit produces hydrogen, water vapor, CO and CO₂ from the air and fuel mixture.

An ATO reactor may comprise any catalytic burner or combustor in which air and a fuel (anode) exhaust streams, from the fuel cell stack are burned. The fuel exhaust stream may possibly be enriched with fresh fuel such as natural gas, propane, ethanol or other hydrocarbons. A non-limiting example of an ATO reactor is shown in U.S. application Ser. No. 11/656,563 hereby incorporated by reference in its entirety, where the ATO reactor is positioned between the outer cylinder and an inner cylinder of a fuel cell system.

The typical design of a venturi involves a conduit with a tapered middle section, although numerous other variations exist. In one example, inlets placed at the tapered region draw fluids into the conduit by virtue of the suction created at the tapered region. As such, a venturi is highly useful as a mixing device, among other things. Depending on the fuel cell system, mixing fluids in a venturi may or may not require the fuel to be at a higher pressure than the venturi outlet.

In one embodiment a venturi comprises a conduit comprising a throat region, an inner wall and an outer wall (i.e. sleeve), said throat region defined by a narrowing of the inner wall. An annular space is formed between the inner wall and the outer wall, said annular space radially circumventing the throat region. At least one inlet is located on said outer wall allowing external access to the annular space. At least one aperture is located on the inner wall connecting the annular space with the interior of the conduit.

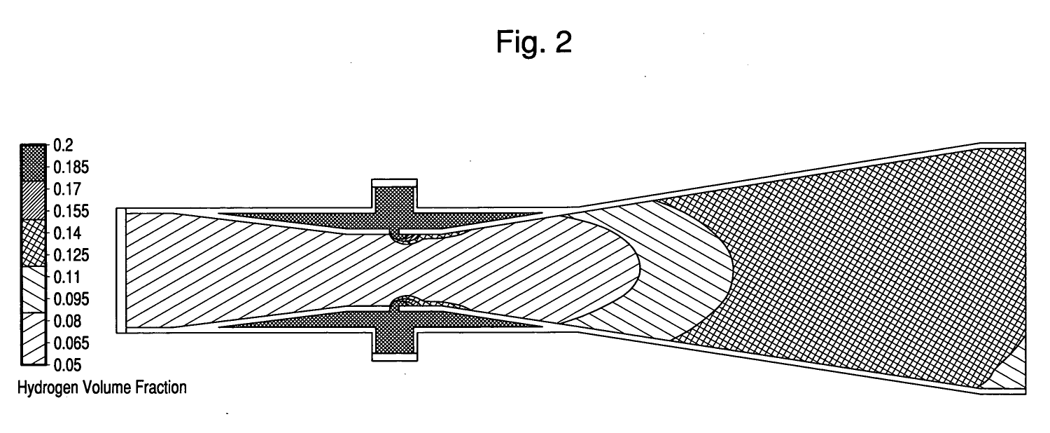

Depending on the preferred design of a venturi, the cross-sectional profile of the annular space may be, for example, trapezoidal or rectangular as shown in FIGS. 2 and 4, respectively. Of course numerous other profiles are possible depending on the design, such as but not limited to: semi-circular, triangular, or other polygonal shapes.

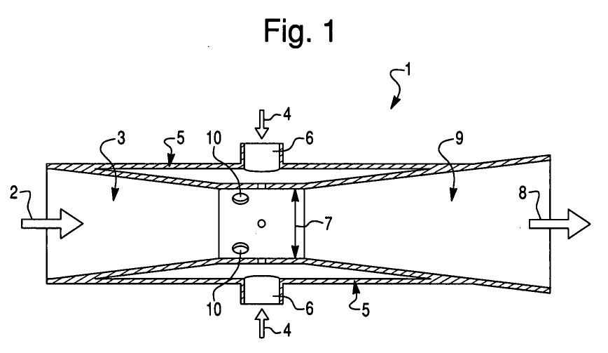

An example of a venturi 1 is shown in FIG. 1 where air 2 enters the venturi tube inlet 3 from the left, fuel 4 enters from the top and bottom into an annulus 5 formed around the throat region 7 of the venturi tube through the inlets 6 and the fuel/air mixture 8 exits the venturi tube through outlet 9. The apertures 10 connect the throat region 7 of the venturi tube to the annulus 5. “Throat region” may be understood as the radially narrowed portion of the venturi tube. Other venturi designs may also be used. The venturi configuration of FIG. 1, was used to define the input for computational fluid dynamics (CFD) simulations which are shown in FIG. 2-FIG. 5.

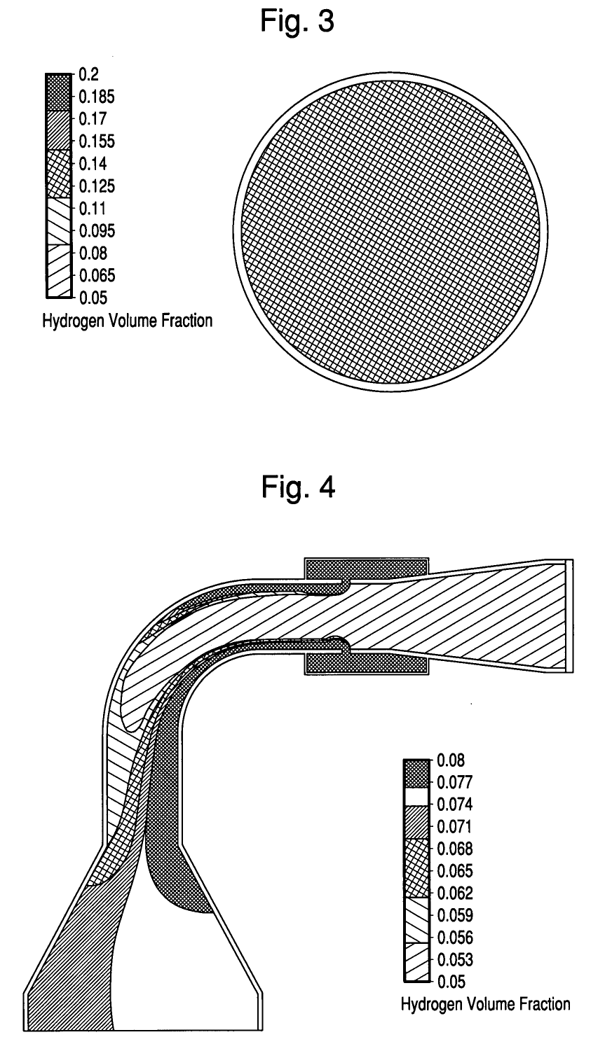

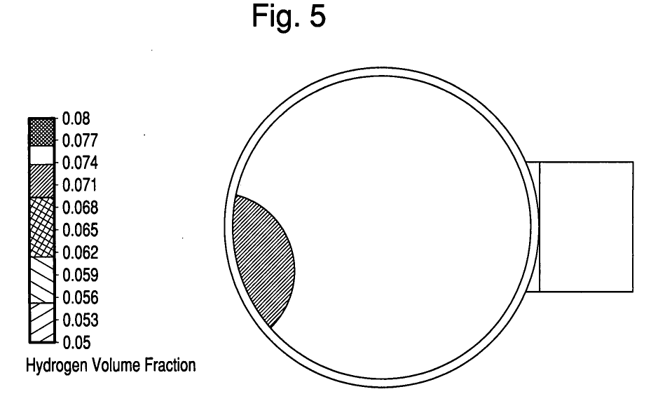

An embodiment of the present invention addresses uniform fuel/air mixing and delivery to catalytic reactors used in fuel cell systems, such as SOFC systems. Here, the fuel mixer comprises a venturi. In this fuel mixer, gas with lower volumetric flow (typically fuel) is injected radially through multiple apertures 10 in the venturi sidewall into the higher volume flow stream (typically air.) This results in an evenly-distributed fuel/air mixture delivery to a catalytic reactor. Even distribution is in terms of both concentration and flow rate. The CFD results illustrated in FIG. 2-FIG. 5 show evenly-distributed fuel delivery to an ATO reactor. FIG. 2-3 show a linear venturi while FIG. 4-5 show a curved venturi.

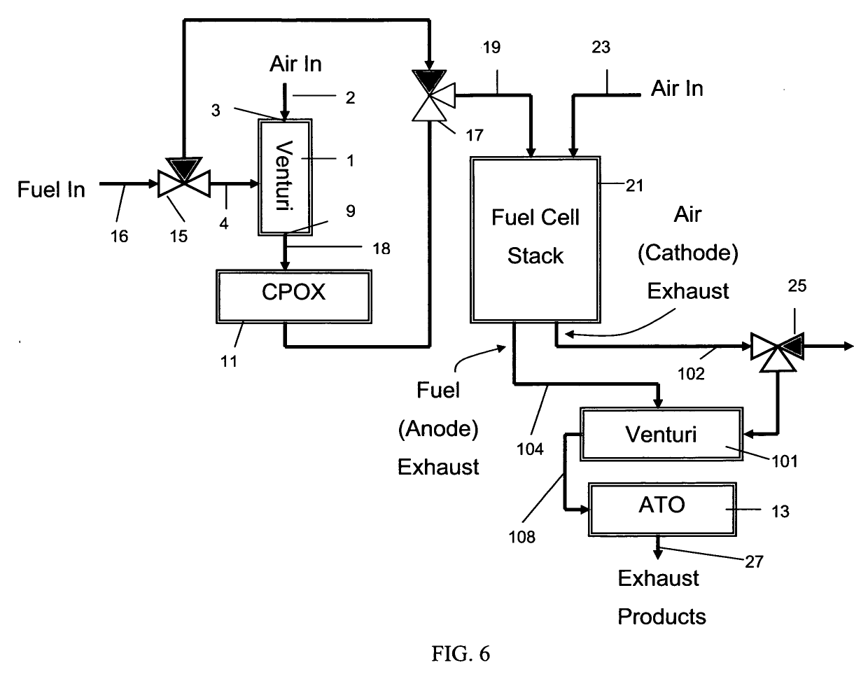

A venturi may be incorporated at various locations about a fuel cell system. FIG. 6 shows two venturis (1 and 101) where one (venturi 1) is positioned to fluidly communicate with a CPOX reactor 11 and the other (venturi 101) with an ATO reactor 13. However, depending on the preferred design, some fuel cell systems may use only one venturi, while others may employ two or more. FIG. 6 is illustrated in a simplified manner to aid in understanding of the general use of a venturi in a fuel cell system and is not intended to limit the scope of the embodiments in any manner. A practical fuel cell system can comprise other elements (than that shown in FIG. 1) which include but are not limited to: steam generator(s), reformer(s), heat exchanger(s), blower(s), condenser(s), vent(s), mixer(s) or any combination thereof. Such elements may be placed upstream or downstream from a venturi, and may or may not be located between a venturi and a catalytic reactor. In addition, the fuel cell system of FIG. 6 may be further modified to include elements of the fuel cell systems disclosed in U.S. application Ser. No. 11/491,487 hereby incorporated by reference in its entirety.

In one example, the CPOX reactor shown in FIG. 6 may be used in the start up mode to produce hydrogen. Preferably the fuel cell system comprises a start-up heater for heating the CPOX reactor. During this stage of operation, the venturi provides a mixture of air and fuel to the CPOX which in turn produces hydrogen. Upon reaching a steady state condition for the system, the CPOX (and the venturi) can be bypassed using the valves (15, 17) shown.

Thus in the start-up mode, the inlet fuel stream flows from fuel inlet 16 through valve 15 into venturi 1 where it is mixed with inlet air stream 2. The mixed fuel and air stream is provided to the CPOX reactor 11 via conduit 18. The CPOX reactor produces a hydrogen stream. The hydrogen stream flows into the fuel cell stack 21 thought valve 17. In steady state mode, the valves 15, 17 are switched to bypass the venturi 1 and CPOX reactor 11. In the steady state mode, the fuel cell stack 21 generates electricity from the fuel and air inlet streams provided from respective inlet conduits 19, 23. The stack provides a fuel or anode exhaust stream through conduit 104, and an air or cathode exhaust stream through conduit 102. The fuel exhaust stream is provided into the venturi 101 where it is mixed with an air inlet stream. The air inlet stream may comprise the stack cathode exhaust stream or a fresh air inlet stream. The air streams are controlled by one or more mixers 25. The mixed fuel exhaust and air stream is provided from venturi 101 into ATO reactor 13 via conduit 108 where they are burned and exhausted via conduit 27. The heat from the ATO reactor may be used to heat a reformer, a water vaporizer, fuel or air inlet streams or other system components.

The fluid streams preferably comprise gas phase fuel and air streams. In one alternative embodiment, fuel is supplied to the venturi in the form of a liquid, optionally under pressure. During mixing of the liquid fuel with the other fluids in the venturi, small droplets comprising fuel are formed which are subsequently dispensed from the venturi. The droplets then quickly evaporate to provide fuel in gaseous form. In this manner, fuel can be supplied to the system in liquid form. In a non-limiting example, liquid ethanol (or another alcohol fuel such as methanol) and heated air are supplied to the venturi. The venturi provides ethanol droplets mixed into the heated air stream into the CPOX reactor.

Numerous benefits flow from embodiments of the present invention. For instance, a low fuel side backpressure can be used due to the venturi effect (as compared to traditional injectors.) Also as noted, a more uniform mixing of fuel and air can be achieved. This in turn results in high fuel conversion rates due to evenly dispersed mixture, more uniform catalyst bed temperature, longer catalyst life due to elimination of hot spots, and a smaller catalytic bed.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

What is claimed is:

1. A fuel cell system comprising:
a fuel cell stack;
at least one catalytic reactor; and
at least one venturi, fluidly connected to said at least one catalytic reactor.

2. The system of claim 1, wherein the at least one venturi is configured to deliver a mixture of fluids to said at least one catalytic reactor.

3. The system of claim 2, wherein:
the mixture comprises fuel and air; and
the system comprises two venturis, each fluidly connected to a separate catalytic reactor.

4. The system of claim 1, wherein:
one venturi is directly connected to an inlet of one catalytic reactor; and
the fuel cell stack comprises a solid oxide fuel cell stack.

5. The system of claim 1, wherein the catalytic reactor comprises a catalytic partial oxidation (CPOX) reactor.

6. The system of claim 1, wherein the catalytic reactor comprises an anode tailgas oxidation (ATO) reactor.

7. The system of claim 1, wherein the venturi comprises:
a conduit comprising a throat region, an inner wall and an outer wall, said throat region defined by a narrowing of the inner wall;
an annular space formed between the inner wall and the outer wall, said annular space radially circumventing the throat region;
at least one inlet located on said outer wall allowing external access to the annular space; and
at least one aperture located on the inner wall connecting the annular space with the interior of the conduit.

8. A method of operating a fuel cell system comprising:
providing a fuel cell system comprising:
a fuel cell stack;
at least one catalytic reactor; and
at least one venturi;
mixing fuel and air in said at least one venturi; and
providing a fuel and air mixture from said at least one venturi to said at least one catalytic reactor.

9. The method of claim 8, wherein one venturi is directly connected to an inlet of one catalytic reactor and the fuel cell stack comprises a solid oxide fuel cell stack.

10. The method of claim 8, wherein said at least one catalytic reactor comprises a catalytic partial oxidation (CPOX) reactor and the fuel comprises a fuel inlet stream.

11. The method of claim 10, further comprising providing a hydrogen stream from the CPOX reactor to the fuel cell stack in a start-up operation mode of the system.

12. The method of claim 8, wherein said at least one catalytic reactor comprises an anode tailgas oxidation (ATO) reactor and the fuel comprises a fuel exhaust stream from the fuel cell stack.

13. The method of claim 10, further comprising:
mixing a fuel exhaust stream from the fuel cell stack with an air stream in a second venturi;
providing an air and fuel exhaust mixture from the second venturi into an ATO reactor; and
burning the mixture in the ATO reactor.

14. The method of claim 13, wherein the fuel exhaust stream is supplemented with fresh fuel prior to being provided into the second venturi.

15. The method of claim 8, wherein said at least one venturi comprises:
a conduit comprising a throat region, an inner wall and an outer wall, said throat region defined by a narrowing of the inner wall;
an annular space formed between the inner wall and the outer wall, said annular space radially circumventing the throat region;
at least one inlet located on said outer wall allowing external access to the annular space; and
at least one aperture located on the inner wall connecting the annular space with the interior of the conduit.

16. The method of claim 8, wherein the system comprises two venturis and two reactors.

17. A venturi configured for mixing two or more different fluids in a fuel cell system, said venturi comprising:
a conduit comprising a throat region, an inner wall and an outer wall, said throat region defined by a narrowing of the inner wall;
an annular space formed between the inner wall and the outer wall, said annular space radially circumventing the throat region;
at least one inlet located on said outer wall allowing external access to the annular space; and
at least one aperture located on the inner wall connecting the annular space with the interior of the conduit.

18. A fuel cell system comprising:
the venturi of claim 17;
a fuel cell stack; and
at least one catalytic reactor;
wherein said venturi is fluidly connected to said at least one catalytic reactor.
